(19) United States
(12) Patent Application Publication
(10) Pub. No.: US 2010/0254330 A1
(43) Pub. Date: Oct. 7, 2010

(54) SIGNAL RECEIVING METHOD AND SIGNAL TRANSMITTING METHOD

(76) Inventors: Nam Suk Lee, Daejeon (KR); Yong Seouk Choi, Daejeon (KR); Sook Jin Lee, Daejeon (KR); Kyung Soo Kim, Daejeon (KR)

Correspondence Address: DOCKET CLERK, P.O. DRAWER 800889, DALLAS, TX, 75380, US

(21) Appl. No.: 12/735,012

(22) PCT Filed: Aug. 20, 2008
(86) PCT No.: PCT/KR2008/004859

§ 371 Date: Jun. 9, 2010

(30) Foreign Application Priority Data
Dec. 11, 2007 (KR) 10-2007-0128424

(51) Int. Cl. H04W 72/04; H04L 27/28

(52) U.S. Cl. 370/329; 375/260

(57) ABSTRACT

A signal receiving method includes allocating a first uplink channel, receiving first mode change data from a mobile station through the first uplink channel, releasing the allocation of the first uplink channel, allocating a second uplink channel for desired mode feedback at predetermined intervals, and receiving first feedback data from the mobile station through the second uplink channel. Therefore, when a mobile station tries to change a mode to another mode, it can perform the mode change with a minimum delay and without a wasteful use of resources.

### TECHNICAL FIELD

The present invention relates to a signal receiving method and a signal transmitting method. In particular, the present invention relates to a signal receiving method and a signal transmitting method for use in a portable Internet system supporting a MIMO (Multiple-Input Multiple-Output) mode.

### BACKGROUND ART

In a portable Internet system, channel modes are classified into a PUSC (partial usage subchannel) mode, an FUSC (full usage subchannel) mode, and a band adaptive modulation and coding (hereinafter, referred to as ‘band AMC’) mode. In the band AMC mode among these modes, when any one of various MIMO modes such as STTD (space time transmit diversity), SM (spatial multiplexing), BF (beam-forming), and PURC (per user unitary rate control) is operated, a mobile station transmits related channel quality information (hereinafter, referred to as ‘CQI’) to a base station.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a signal transmitting method, a signal receiving method, and a mode changing method having advantages of enabling effective resource use and a change to a feedback mode in a portable Internet system supporting multiple antennas.

### Technical Solution

An exemplary embodiment of the present invention provides a signal receiving method including allocating a first uplink channel, receiving first mode change data from a mobile station through the first uplink channel, releasing the allocation of the first uplink channel, allocating a second uplink channel for desired mode feedback at predetermined intervals, and receiving first feedback data from the mobile station through the second uplink channel.

The first feedback data may include information on a mode change intention.

The mode change intention may be defined as 1-bit data of the first feedback data.

If there is a mode change intention, the signal receiving method may further include allocating a third uplink channel, and receiving second mode change data from the mobile station through the third uplink channel.

If the mode change intention represents change from a MIMO mode to another MIMO mode, the signal receiving method may further include releasing the allocation of the third uplink channel, allocating a fourth uplink channel for feedback of the another MIMO mode, and receiving second feedback data from the mobile station through the allocated fourth uplink channel.

If the mode change intention represents change of a MIMO mode to another input/output mode, the signal receiving method may further include receiving channel quality information from the mobile station through the third uplink channel.

The first feedback data may include mode change data.

When a MIMO mode is changed to another MIMO mode, the signal receiving method may further include receiving the first feedback data including the mode change intention and the mode change data on the another MIMO mode from the mobile station, allocating an uplink channel for the another MIMO mode feedback, and receiving second feedback data from the mobile station through the allocated uplink channel.

When a MIMO mode is changed to another input/output mode, the signal receiving method may further include receiving the first feedback data including the mode change intention and the mode change data on the another mode from the mobile station, allocating a third uplink channel, and receiving channel quality information from the mobile station through the third uplink channel.

The first feedback data may include the channel quality information.

Another embodiment of the present invention provides a signal transmitting method including transmitting first mode change data through an allocated first uplink channel, and transmitting first feedback data through an allocated second uplink channel for feedback of a desired mode. In the signal transmitting method, the first feedback data may include information on whether a mode change has been performed.

If there is a mode change intention, the signal transmitting method may further include transmitting the first feedback data including the mode change intention through the second uplink channel, and transmitting second mode change data through an allocated third uplink channel.

If a MIMO mode has been changed to another MIMO mode, the signal transmitting method may further include transmitting second feedback data through an allocated fourth uplink channel for feedback of the another MIMO mode.

If a MIMO mode is changed to another input/output mode, the signal transmitting method may further include transmitting channel quality information through the third uplink channel.

The feedback data may further include the desired mode information.

If a MIMO mode is changed to another MIMO mode, the signal transmitting method may further include transmitting the first feedback data including the mode change intention and information on the another MIMO mode, and transmitting second feedback data through an allocated third uplink channel for feedback of the another MIMO mode.

If a MIMO mode is changed into another input/output mode, the signal transmitting method may further include transmitting the first feedback data including the mode change intention and information on the another input/output mode, and transmitting second feedback information through an allocated third uplink channel.

### ADVANTAGEOUS EFFECTS

According to the exemplary embodiments of the present invention, it is possible to change the operation mode of a mobile station from one mode to another mode with a minimum delay without a wasteful use of resources.

### BRIEF DESCRIPTION OF THE DRAWINGS

FIG. 1 is a diagram illustrating various types of MAC headers.

FIG. 2 is a signal flowchart illustrating a mode change method according to a first exemplary embodiment of the present invention.

FIG. 3 is a drawing illustrating a feedback header II according to a second exemplary embodiment of the present invention.

FIG. 4 is a signal flowchart illustrating a mode changing method according to an exemplary embodiment of the present invention adapting the feedback header II shown in FIG. 3.

FIG. 5 is a signal flowchart illustrating a mode changing method according to another exemplary embodiment adapting the feedback header II shown in FIG. 3.

FIG. 6 is a drawing illustrating a feedback header II according to a third exemplary embodiment of the present invention.

FIG. 7 is a signal flowchart illustrating a mode changing method according to an exemplary embodiment adapting the feedback header II shown in FIG. 6.

FIG. 8 is a signal flowchart illustrating a mode changing method according to another exemplary embodiment adapting the feedback header II shown in FIG. 6.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise”, and variations such as “comprises” and “comprising”, will be understood to imply the inclusion of stated elements but not the exclusion of any other elements. In addition, the terms “-er”, “-or”, and “module” described in the specification mean units for processing at least one function and operation and can be implemented by hardware components, software components, and combinations thereof.

In this specification, a mobile station (MS) may designate a terminal, a mobile terminal (MT), a subscriber station (SS), a portable subscriber station (PSS), user equipment (UE), an access terminal (AT), etc., and may include functions of all or part of the terminal, the mobile terminal, the subscriber station, the portable subscriber station, the user equipment, the access terminal, etc.

In this specification, a base station (BS) may represent an access point (AP), a radio access station (RAS), a node B, a base transceiver station (BTS), a mobile multihop relay (MMR)-BS, and the like. Further, the base station may have the entire or partial function of the access point, the radio access station, the node B, the base transceiver station, the MMR-BS, and the like.

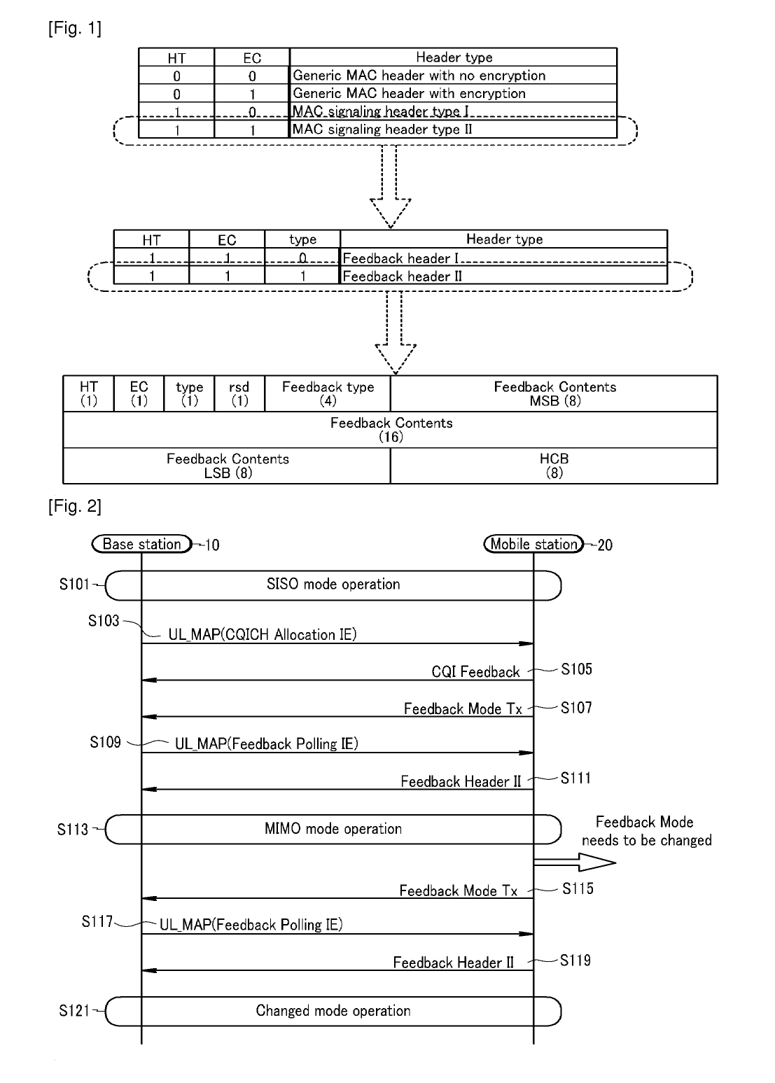

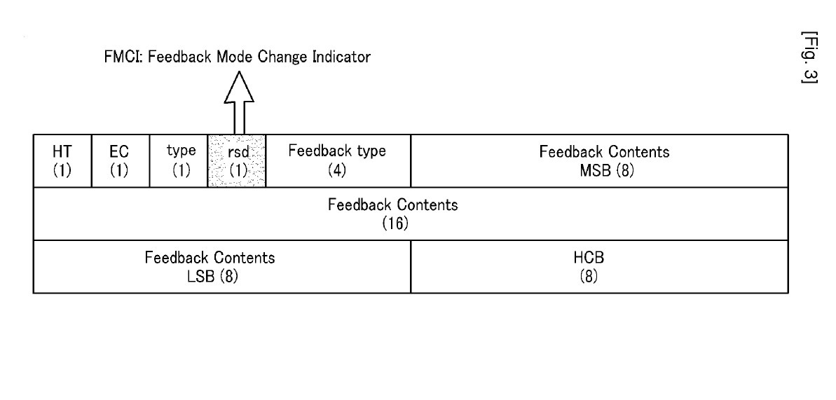

Hereinafter, a mode changing method according to an exemplary embodiment of the present invention will be described with reference to FIGS. 1 and 2.

FIG. 1 is a diagram illustrating various types of MAC headers, and FIG. 2 is a signal flowchart illustrating a mode change method according to a first exemplary embodiment of the present invention.

A communication system according to an exemplary embodiment of the present invention includes base stations 10 and mobile stations 20. Each of the base stations 10 takes charge of a cell. A cell may include a plurality of sectors, and a base station 10 communicates with mobile stations 20 in a corresponding cell.

Referring to FIG. 1, MAC (medium access control) headers are generally classified into four types.

A MAC signaling header type II among these four types of MAC headers is used for a mobile station to feed information, for example channel quality information (CQI), back to a base station 10. The MAC signaling header type II is classified into a feedback header I and a feedback header II according to the feedback information.

In the band AMC mode, when any one of various MIMO modes is operated, the feedback header II is used to transmit related CQI to a base station.

The feedback header II includes a feedback contents field, a feedback type field, and a reserved (rsd) field.

Referring to FIG. 2, when a mobile station 20 supporting the MIMO mode initially accesses a base station 10, it operates in a PUSC SISO (partial usage subchannel single-input single-output) mode (S101).

In order to acquire the CQI from the mobile station 20, the base station 10 transmits an uplink map (hereinafter referred to as ‘UP_MAP’) including a channel quality indicator channel (hereinafter, referred to as ‘CQICH’) allocation IE (S103). The CQICH allocation IE includes resource allocation information that allows the mobile station 20 to transmit CQI at predetermined intervals, and interval information that allows the mobile station to transmit changed feedback mode information.

The mobile station 20 measures the quality of an allocated channel and feeds the CQI back to the base station through the channel (S105).

Meanwhile, in order to change the operation mode from the PUSC SISO mode to a SIMO or MIMO mode, the mobile station 20 transmits mode information to be changed (feedback mode information) to the base station 10 through an allocated CQICH (S107).

For example, in order to change the operation mode to a band AMC MIMO mode, the mobile station transmits 6-bit feedback mode information indicating the band AMC MIMO mode to the base station 10 through a CQICH allocated during a predetermined interval.

The base station receives the CQI from the mobile station 20, and transmits an UP_MAP including a feedback polling IE having uplink resource allocation information for acquiring CQI related to the band AMC MIMO mode (S109).

The mobile station 20 transmits a feedback header II including the CQI related to the band AMC MIMO mode to the base station 10 through an uplink resource allocated by the feedback polling IE (S111).

Then, the mobile station 20 and the base station 10 operate in the changed band AMC MIMO mode (S113).

In this case, the base station 10 does not release the allocation of the CQICH but allocates the CQICH at predetermined intervals to enable the mobile station 20 to request mode change.

Meanwhile, when the mobile station 20 operating in an arbitrary band AMC MIMO mode tries to change the operation mode to a PUSC SIMO mode or another band AMC MIMO mode, the mobile station 20 transmits feedback mode information indicating a desired operation mode to the base station 10 through the allocated CQICH (S115).

The base station 10 transmits an UP_MAP including a feedback polling IE for CQI feedback according to the operation mode requested by the mobile station 20 (S117).

The mobile station 20 transmits a feedback header II including CQI through the allocated channel (S119), and operates in the desired another mode (S121).

Meanwhile, the base station 10 allocates the CQICH at predetermined intervals while the mobile station 20 operates in the band AMC MIMO mode.

Now, a mode changing method capable of reducing resource allocation for a mode changing request will be described.

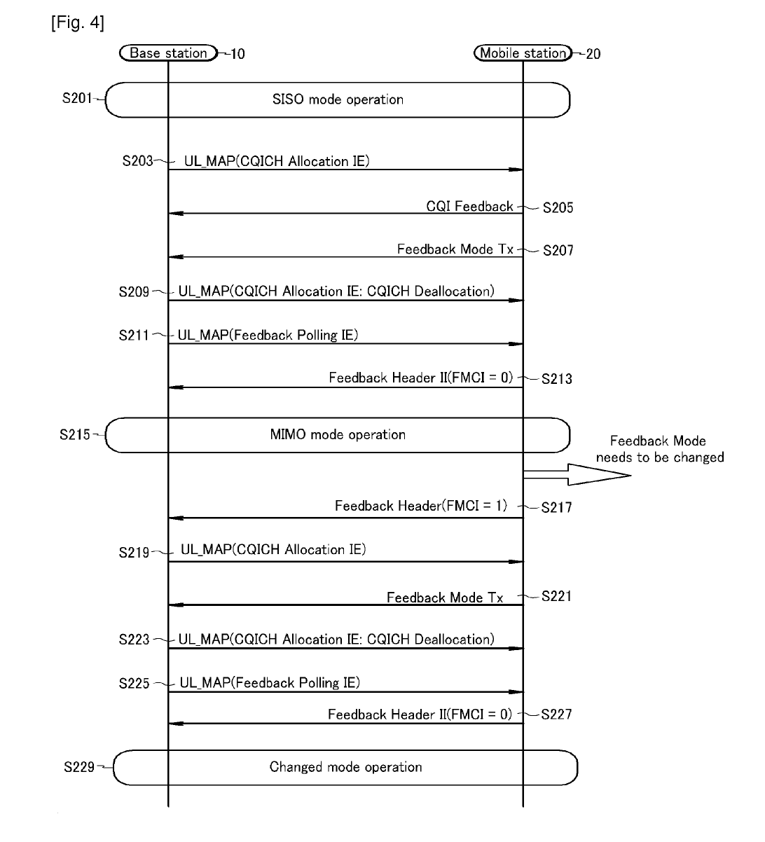

FIG. 3 is a drawing illustrating a feedback header II according to a second exemplary embodiment of the present invention, and FIG. 4 is a signal flowchart illustrating a mode changing method according to an exemplary embodiment of the present invention adapting the feedback header II shown in FIG. 3.

Referring to FIG. 3, a feedback header II according to the second exemplary embodiment of the present invention includes a feedback mode change indicator (hereinafter, referred to as ‘FMCI’) reporting a feedback mode change.

The FMCI is included in a 1-bit rsd field of the feedback header II.

In other words, the rsd field includes the FMCI. If the mobile station 10 wants a mode change, it sets the value of the rsd field to 1 and transmits the feedback header II, but if the mobile station 10 doses not want a mode change, it sets the value of the rsd field to 0 and transmits the feedback header II.

Referring to FIG. 4, the mobile station 20 initially operates in a SISO mode (S201). The base station 10 transmits an UL_MAP including a CQICH allocation IE indicating a CQICH to acquire the CQI from the mobile station 20 (S203).

The mobile station 20 measures the quality of the channel and feeds the CQI back to the base station 10 through the allocated channel (S205).

Meanwhile, in order to change the operation mode from the PUSC SISO mode to the SIMO or MIMO mode, the mobile station 20 transmits information on the desired mode (feedback mode information) to the base station 10 through the allocated CQICH (S207).

For example, if the desired mode is the band AMC MIMO mode, the mobile station transmits 6-bit feedback mode information indicating the band AMC MIMO mode to the base station 10 through the CQICH allocated during a predetermined interval (S207).

The base station 10 receives the feedback mode information, and transmits, to the mobile station 20, a UL_MAP including a CQICH allocation IE representing release information for releasing the allocation of the CQICH (S209).

After the base station 10 releases the allocation of the CQICH, the base station allocates an uplink resource at predetermined intervals so that the mobile station 20 can feed the CQI in the band AMC MIMO mode back, and transmits a UL_MAP including a feedback polling IE representing uplink resource allocation information (S211).

The mobile station 20 receives the UL_MAP, and transmits a feedback header II having the FMCI set to 0 through the allocated uplink resource of the feedback polling IE (S213).

Then, the base station 10 does not allocate the CQICH any more, and the base station 10 and the mobile station 20 operate in the MIMO mode (S215).

Meanwhile, if the mobile station 20 wants to change the operation mode from the band AMC MIMO mode to another band AMC MIMO mode, in order to transmit the CQI, the mobile station transmits the feedback header II having the FMCI set to 1 (S217).

If the base station 10 receives the feedback header II having the FMCI set to 1, the base station 10 transmits a UL_MAP including a CQICH allocation IE so that feedback mode information (feedback mode) can be fed back (S219).

The mobile station 20 transmits 6-bit feedback mode information representing a predetermined band AMC MIMO mode to the base station 10 through the allocated CQICH (S221).

If the base station 10 receives the feedback mode information, the base station 10 releases the allocation of the CQICH, and transmits a UL_MAP including a CQICH allocation IE representing the allocation release to the mobile station 20 (S223).

Further, the base station 10 allocates an uplink resource so that CQI according to the feedback mode information can be transmitted, and transmits a UL_MAP including a feedback polling IE to the mobile station 20 (S225).

The mobile station 20 transmits the feedback header II, which includes CQI in the band AMC MIMO mode and the FMCI set to 0, through an uplink channel allocated according to the feedback polling IE (S227).

If the base station 10 receives the feedback header II including the FMCI set to 0, the base station does not allocate the CQICH, and the base station 10 and the mobile station 20 operate in the changed band AMC MIMO mode (S229).

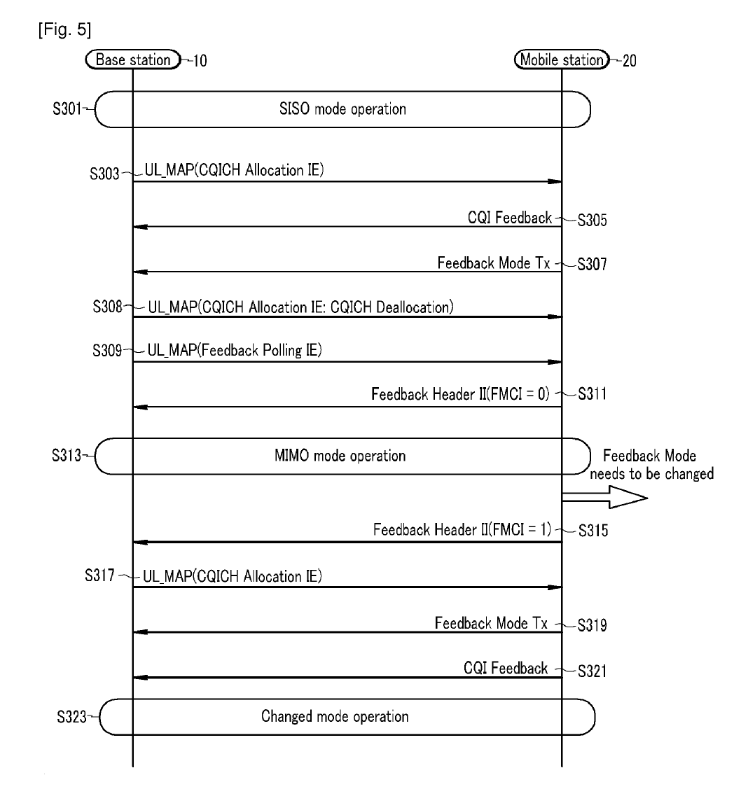

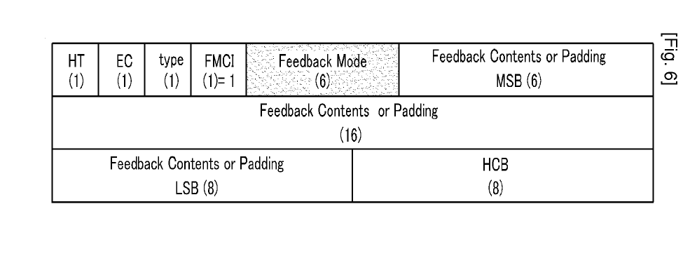

FIG. 5 is a signal flowchart illustrating a mode changing method according to another exemplary embodiment adapting the feedback header II shown in FIG. 3.

Referring to FIG. 5, the base station 10 and the mobile station 20 change the operation mode from the initial SISO mode to the band AMC MIMO mode in the same manner as that illustrated in FIG. 4 (S301 to S313).

If the mobile station 20 wants to change the operation mode to the PUSC SIMO or PUSC SISO mode while the base station 10 and the mobile station 20 are operating in a predetermined band AMC MIMO mode, the mobile station 20 transmits a feedback header II including a FMCI field having a value of 1 to the base station 10 (S315).

If the base station 10 receives the feedback header II, the base station 10 allocates a CQICH so that the mobile station 20 can request a feedback mode change, and transmits a UL_MAP including a CQICH allocation IE representing the allocation information (S317). The mobile station 20 transmits feedback mode information to the base station 10 through the allocated CQICH (S319).

Further, the mobile station 20 transmits CQI in the PUSC SIMO or SISO mode to the base station 10 through a CQICH allocated at the next interval (S321).

In other words, if the transmitted feedback mode information represents the PUSC SIMO or SISO mode, the base station 10 does not release the allocation of the CQICH, and the mobile station 20 transmits the CQI in the PUSC SIMO or SISO mode to the base station 10 through the CQICH allocated at the next interval.

As described above, it is possible to release the allocation of the CQICH during an interval when mode change is not performed, thereby preventing a wasteful use of resources.

Hereinafter, another method of preventing a wasteful use of resources during mode change will be described with reference to FIGS. 6 to 8.

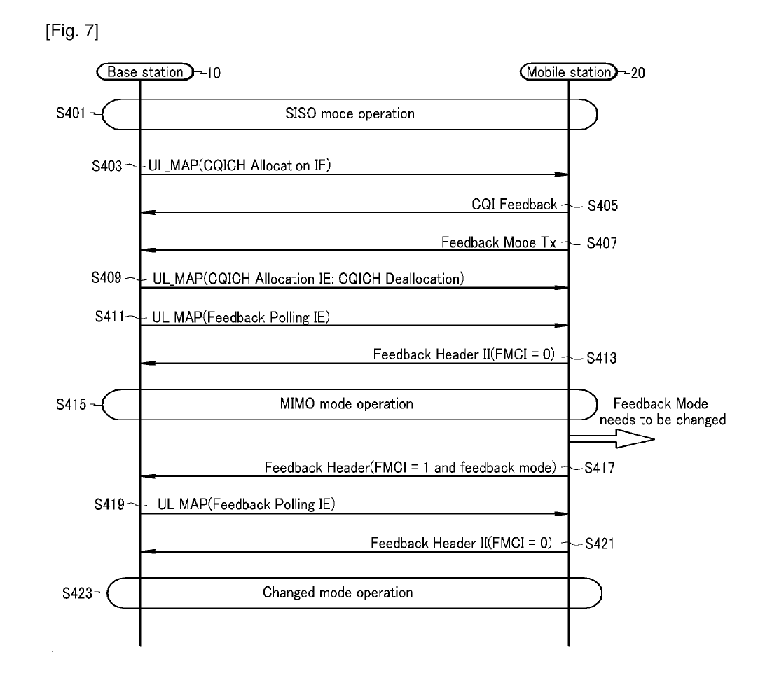

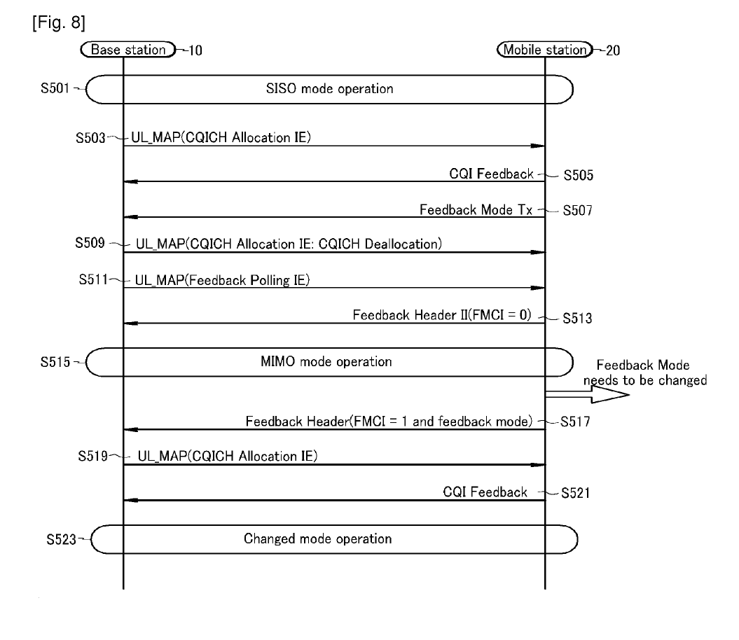

FIG. 6 is a drawing illustrating a feedback header II according to a third exemplary embodiment of the present invention, FIG. 7 is a signal flowchart illustrating a mode changing method according to an exemplary embodiment adapting the feedback header II shown in FIG. 6, and FIG. 8 is a signal flowchart illustrating a mode changing method according to another exemplary embodiment adapting the feedback header II shown in FIG. 6.

Referring to FIG. 6, a feedback header II includes an rsd field that follows an FMCI field and stores 6-bit feedback mode information for a mode change request.

Referring to FIG. 7, the mobile station 20 and the base station 10 initially operate a SISO mode, and change the operation mode from the initial SISO mode to an arbitrary band AMC MIMO mode in the same manner as that illustrated in FIG. 4 (S401 to S415).

If the mobile station 20 wants to change the operation mode from an arbitrary band AMC MIMO mode to another band AMC MIMO mode, the mobile station 20 transmits, to the base station 10, the feedback header II that includes the FMCI field set to 1 and 6-bit feedback mode information representing the another band AMC MIMO mode (S417).

If the base station 10 receives the feedback header II including the FMCI field set to 1, the base station 10 allocates an uplink resource to the base station to feed back CQI in the band AMC MIMO mode represented by the feedback mode information. The base station 10 transmits, to the mobile station 20, a UL_MAP including a feedback polling IE representing the allocation information (S419).

The mobile station 20 receives the UL_MAP, changes the operation mode to the requested band AMC MIMO mode, and transmits the feedback header II including the CQI and the FMCI set to 0 through the allocated uplink resource (S421).

Then, the mobile station 20 and the base station 10 change the operation mode without allocating a separate channel for transmitting or receiving the feedback mode information (S423).

Meanwhile, the mobile station 20 and the base station 10 initially operate a SISO mode as shown in FIG. 8, and change the operation mode from the initial SISO mode to an arbitrary band AMC MIMO mode in the same manner as that illustrated in FIG. 4 (S501-S515).

If the mobile station 20 wants to change the operation mode from a predetermined band AMC MIMO mode to the PUSC SIMO or SISO mode, the mobile station 20 transmits, to the base station 10, the feedback header II which includes the FMCI field set to 1 and 6-bit feedback mode information representing the PUSC SIMO or SISO mode (S517).

If the base station 20 receives the feedback header II including the FMCI field set to 1 and the feedback mode information representing the PUSC SIMO or SISO mode, the base station 20 allocates a CQICH, and transmits a UL_MAP including a CQICH allocation IE having the allocation information to the mobile station 20 (S519).

The mobile station 20 changes the operation mode from the band AMC MIMO mode to the PUSC SIMO or SISO mode, and then transmits CQI to the base station 10 through the allocated CQICH (S521).

As described above, if the feedback header II is used to transmit the feedback mode information, it is possible to prevent a wasteful use of resources and to reduce delay due to transmission of feedback mode information through a separate channel.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A signal receiving method comprising:
allocating a first uplink channel;
receiving a first mode change data from a mobile station through the first uplink channel;
releasing the allocation of the first uplink channel;
allocating a second uplink channel for a desired mode feedback at predetermined intervals; and
receiving a first feedback data from the mobile station through the second uplink channel.

2. The signal receiving method of claim 1, wherein:
the first feedback data includes information indicating whether a mode change intention exists.

3. The signal receiving method of claim 2, wherein:
the mode change intention is defined as 1-bit data of the first feedback data.

4. The signal receiving method of claim 3, further comprising:
allocating a third uplink channel in response to the indication that the mode change intention exists; and
receiving a second mode change data from the mobile station through the third uplink channel.

5. The signal receiving method of claim 4, further comprising:
if the mode change intention represents change from a multiple-input-multiple-output (MIMO) mode to another MIMO mode:
releasing the allocation of the third uplink channel,
allocating a fourth uplink channel for feedback of the another MIMO mode, and
receiving a second feedback data from the mobile station through the allocated fourth uplink channel.

6. The signal receiving method of claim 4, further comprising:
if the mode change intention represents change of a MIMO mode to another input/output mode,
receiving channel quality information from the mobile station through the third uplink channel.

7. The signal receiving method of claim 3, wherein:
the first feedback data includes mode change data.

8. The signal receiving method of claim 7, further comprising:
when a multiple-input-multiple-output (MIMO) mode is changed to another MIMO mode:
receiving the first feedback data including the mode change intention and the mode change data on the another MIMO mode from the mobile station,
allocating a third uplink channel for the another MIMO mode feedback, and
receiving second feedback data from the mobile station through the third uplink channel.

9. The signal receiving method of claim 7, further comprising:
when a multiple-input-multiple-output (MIMO) mode is changed to another input/output mode,
receiving the first feedback data including the mode change intention and the mode change data on the another input/output mode from the mobile station;
allocating a fourth uplink channel; and
receiving channel quality information from the mobile station through the fourth uplink channel.

10. The signal receiving method of claim 8, wherein:
the first feedback data includes the channel quality information.

11. A signal transmitting method comprising:
transmitting a first mode change data through an allocated first uplink channel; and
transmitting a first feedback data through an allocated second uplink channel for feedback of a desired mode,
wherein the first feedback data includes information indicating whether a mode change has been performed.

12. The signal transmitting method of claim 11, further comprising:
if a mode change intention exists, transmitting the first feedback data including the mode change intention through the second uplink channel; and
transmitting a second mode change data through an allocated third uplink channel.

13. The signal transmitting method of claim 12, further comprising:
if a multiple-input-multiple-output (MIMO) mode has been changed to another MIMO mode,
transmitting a second feedback data through an allocated fourth uplink channel for feedback of the another MIMO mode.

14. The signal transmitting method of claim 12, further comprising:
if a multiple-input-multiple-output (MIMO) mode is changed to another input/output mode,
transmitting channel quality information through the third uplink channel.

15. The signal transmitting method of claim 11, wherein:
the first feedback data further includes the desired mode information.

16. The signal transmitting method of claim 15, further comprising:
if a multiple-input-multiple-output (MIMO) mode is changed to another MIMO mode,
transmitting the first feedback data including the mode change intention and information on the another MIMO mode; and
transmitting second feedback data through an allocated third uplink channel for feedback of the another MIMO mode.

17. The signal transmitting method of claim 15, further comprising:
if a multiple-input-multiple-output (MIMO) mode is changed into another input/output mode,
transmitting the first feedback data including the mode change intention and information on the another input/output mode; and
transmitting second feedback information through an allocated third uplink channel.

18. The signal transmitting method of claim 11, further comprising:
transmitting channel quality information through the first uplink channel prior to transmitting the first mode change data.

19. The signal transmitting method of claim 15, wherein the first feedback data is included in a feedback header.

20. The signal transmitting method of claim 19, wherein the information indicating whether a mode change has been performed is represented by a 1-bit data in the feedback header.
